(19) United States
(12) Patent Application Publication
(10) Pub. No.: US 2023/0348820 A1
(43) Pub. Date: Nov. 2, 2023

(54) Fabric Care Composition

(71) Applicant: Colgate-Palmolive Company, New York, NY (US)

(72) Inventors: Oscar BAUTISTA CID, Mexico D.F. (MX); Erick CARDENAS ALPIZAR, Mexico D.F. (MX); Raul Arellano MALDONADO, Mexico D.F. (MX); Jose BUCIO, Guanajuato (MX); Alp URAY, Mountainside, NJ (US); Jose Javier TOVAR PESCADOR, Mexico D.F. (MX); Sandra Paola SANCHEZ, Mexico D.F. (MX)

(73) Assignee: Colgate-Palmolive Company, New York, NY (US)

(21) Appl. No.: 18/347,230

(22) Filed: Jul. 5, 2023

Related U.S. Application Data
(62) Division of application No. 16/629,172, filed on Jan. 7, 2020.
(60) Provisional application No. 62/530,493, filed on Jul. 10, 2017.

(51) Int. Cl. C11D 3/30; C11D 3/00

(52) U.S. Cl. CPC C11D 3/30; C11D 3/0015

(57) ABSTRACT

A fabric care composition, including a fabric softening agent including esterquat and a co-softening agent including polyquaternium-7.

### CROSS-REFERENCE TO RELATED APPLICATIONS

This application claims priority to U.S. Provisional Patent Application No. 62/530,493, filed Jul. 10, 2017, which is incorporated herein by reference.

### BACKGROUND

Fabric care compositions are generally used during the rinse or drying cycle of a laundry process to improve various characteristics of laundered fabric articles, such as softness, fragrance, static reduction, and ease of ironing. Typically, liquid fabric care compositions are used in the rinse cycle and solid fabric care compositions are used in the drying cycle, usually incorporated onto woven substrates placed in the laundry dryer.

Esterquats, a quaternary ammonium compound, are a common active ingredient of liquid fabric care compositions used to achieve the desired softness, fragrance, static reduction, and/or ease of ironing characteristics. Esterquats are typically formed when the reaction product of long chain fatty acids and a tertiary amine is esterified in the presence of an acid catalyst and subsequently quaternized to obtain quaternary ammonium salts. Esterquats are commonly a mixture of mono-, di- and triester components.

However, esterquats can also be one of the main cost components of a fabric care composition due to the cost of the raw materials required for their production and their complicated chemistry. In addition, their chemical properties also make it hard to replace, adjust, or add other ingredients to the fabric care composition without affecting its performance.

Accordingly, it would be useful to develop more cost effective fabric care compositions with a reduced amount of esterquat that, nonetheless, provide comparable performance to known esterquat-containing fabric care compositions.

### BRIEF SUMMARY

This summary is intended merely to introduce a simplified summary of some aspects of one or more embodiments of the present disclosure. Further areas of applicability of the present disclosure will become apparent from the detailed description provided hereinafter. This summary is not an extensive overview, nor is it intended to identify key or critical elements of the present teachings, nor to delineate the scope of the disclosure. Rather, its purpose is merely to present one or more concepts in simplified form as a prelude to the detailed description below.

The foregoing and/or other aspects and utilities embodied in the present disclosure may be achieved by providing a fabric care composition, including a fabric softening agent in an amount of 20 weight % or less, based on a total weight of the fabric care composition, wherein the fabric softening agent includes esterquat; and a co-softening agent in an amount of 0.30 weight % or less, based on the total weight of the fabric care composition, wherein the co-softening agent includes polyquaternium-7.

In another embodiment, the fabric care composition comprises no surfactants other that the esterquat.

In another embodiment, the fabric care composition has a viscosity from 30 to 500 cP.

In another embodiment, the fabric softening composition further includes an aqueous carrier; a fragrance; a thickener; a preservative; and a colorant.

In another embodiment, the fabric softening composition includes 15 weight % or less esterquat; from 0.05 weight % to 0.25 weight % polyquaternium-7; from 0.3 weight % to 3 weight % fragrance; 0.001 weight % or more thickener; and 0.2 weight % or less preservative.

In another embodiment, the fabric softening agent consists of esterquat and the co-softening agent consists of polyquaternium-7.

The foregoing and/or other aspects and utilities embodied in the present disclosure may also be achieved by providing a fabric care composition, including a fabric softening agent mixture consisting essentially of 5 weight % or less esterquat and from 0.05 weight % to 0.20 weight % polyquaternium-7, based on a total weight of the fabric care composition, wherein the fabric care composition includes no other fabric softening agents.

In another embodiment, the fabric care composition comprises no surfactants other that the esterquat.

In another embodiment, the fabric care composition has a viscosity from 30 to 500 cP.

In another embodiment, the fabric softening composition further includes an aqueous carrier; from 0.3 weight % to 3 weight % fragrance; 0.001 weight % or more thickener; and 0.2 weight % or less preservative.

In another embodiment, the fabric softening agent mixture is a stable and water soluble liquid mixture.

In another embodiment, the amount of esterquat and polyquaternium-7 in the fabric softening composition is based on the following Formula I: Y=−0.0043X²+0.0649X−0.0037, wherein X is the amount of esterquat to be replaced and Y is the amount of polyquaternium-7.

The foregoing and/or other aspects and utilities embodied in the present disclosure may also be achieved by providing a method of creating a reduced-esterquat fabric care composition, including determining the amount of esterquat in a known fabric care composition; modifying the known fabric care composition by substituting x weight % esterquat with x weight % polyquaternium-7; and creating a reduced-esterquat fabric care composition based on the modified fabric care composition, wherein the reduced-esterquat fabric care composition has at least an equivalent performance to the known fabric care composition with respect to at least one of softness, ease of ironing, and wrinkle reduction.

In another embodiment, the reduced-esterquat fabric care composition includes no surfactants other that the esterquat.

In another embodiment, the reduced-esterquat fabric care composition includes no other fabric softening agents other that the esterquat and the polyquaternium-7.

In another embodiment, the reduced-esterquat fabric care composition has a viscosity from 50 to 300 cP.

In another embodiment, the reduced-esterquat fabric care composition further includes an aqueous carrier; from 0.3 weight % to 3 weight % fragrance; 0.001 weight % or more thickener; and 0.2 weight % or less preservative.

### DETAILED DESCRIPTION

Reference will now be made in detail to the various embodiments in the present disclosure. The embodiments are described below to provide a more complete understanding of the components, processes, compositions, and apparatuses disclosed herein. Any examples given are intended to be illustrative, and not restrictive. However, it will be apparent to one of ordinary skill in the art that the invention may be practiced without these specific details. In other instances, well-known methods, procedures, and components have not been described in detail so as not to unnecessarily obscure aspects of the embodiments.

Throughout the specification and claims, the following terms take the meanings explicitly associated herein, unless the context clearly dictates otherwise. The phrases “in some embodiments” and “in an embodiment” as used herein do not necessarily refer to the same embodiment(s), though they may. Furthermore, the phrases “in another embodiment” and “in some other embodiments” as used herein do not necessarily refer to a different embodiment, although they may. As described below, various embodiments may be readily combined, without departing from the scope or spirit of the present disclosure.

As used herein, the term “or” is an inclusive operator, and is equivalent to the term “and/or,” unless the context clearly dictates otherwise. The term “based on” is not exclusive and allows for being based on additional factors not described, unless the context clearly dictates otherwise. In the specification, the recitation of “at least one of A, B, and C,” includes embodiments containing A, B, or C, multiple examples of A, B, or C, or combinations of A/B, A/C, B/C, A/B/B/BB/C, AB/C, etc. In addition, throughout the specification, the meaning of “a,” “an,” and “the” include plural references. The meaning of “in” includes “in” and “on.”

It will also be understood that, although the terms first, second, etc. may be used herein to describe various elements, these elements should not be limited by these terms. These terms are only used to distinguish one element from another. For example, a first object, component, or step could be termed a second object, component, or step, and, similarly, a second object, component, or step could be termed a first object, component, or step, without departing from the scope of the invention. The first object, component, or step, and the second object, component, or step, are both, objects, component, or steps, respectively, but they are not to be considered the same object, component, or step. It will be further understood that the terms “includes,” “including,” “comprises” and/or “comprising,” when used in this specification, specify the presence of stated features, steps, operations, elements, and/or components, but do not preclude the presence or addition of one or more other features, steps, operations, elements, components, and/or groups thereof. Further, as used herein, the term “if” may be construed to mean “when” or “upon” or “in response to determining” or “in response to detecting,” depending on the context.

All physical properties that are defined hereinafter are measured at 20° to 25° Celsius unless otherwise specified.

When referring to any numerical range of values herein, such ranges are understood to include each and every number and/or fraction between the stated range minimum and maximum, as well as the endpoints. For example, a range of 0.5-6% would expressly include all intermediate values of, for example, 0.6%, 0.7%, and 0.9%, all the way up to and including 5.95%, 5.97%, and 5.99%, among many others. The same applies to each other numerical property and/or elemental range set forth herein, unless the context clearly dictates otherwise.

Additionally, all numerical values are “about” or “approximately” the indicated value, and take into account experimental error and variations that would be expected by a person having ordinary skill in the art. It should be appreciated that all numerical values and ranges disclosed herein are approximate values and ranges, whether “about” is used in conjunction therewith.

Unless otherwise specified, all percentages and amounts expressed herein and elsewhere in the specification should be understood to refer to percentages by weight. The amounts given are based on the active weight of the material. Unless otherwise specified, all component or composition amounts are in reference to the active amount of that component or composition, and exclude impurities or by-products, which may be present in commercially available sources.

With regard to procedures, methods, techniques, and workflows that are in accordance with some embodiments, some operations in the procedures, methods, techniques, and workflows disclosed herein may be combined and/or the order of some operations may be changed.

A fabric care composition as disclosed herein includes a fabric softening agent and a co-softening agent. The fabric care compositions may be in liquid form and may include an aqueous carrier.

The fabric care composition includes one or more fabric softening agents. In certain embodiments, the fabric softening agent is a cationic softener selected from among esterquats, imidazolinium quats, difatty diamide ammonium methyl sulfate, ditallow dimethyl ammonium chloride, and mixtures thereof. For example, in certain embodiments, the fabric softening agent is an esterquat of the following formula:

Formula 1:

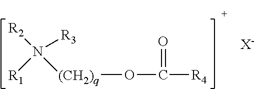

wherein R₄ is an aliphatic hydrocarbon group having from 8 to 22 carbon atoms, R₂ and R₃ represent (CH₂)₅—R₅, where R₅ is an alkoxy carbonyl group containing from 8 to 22 carbon atoms, benzyl, phenyl, C₁-C₄ alkyl substituted phenyl, OH or H; R₁ is (CH₂)ₜ—R₆, where R₆ is benzyl, phenyl, C₁-C₄ alkyl substituted phenyl, OH or H; q, s, and t, each independently, are an integer from 1 to 3; and X⁻ is a softener compatible anion.

The esterquat may be produced by reacting about 1.65 (1.5 to 1.75) moles of fatty acid methyl ester with one mole of alkanol amine followed by quaternization with dimethyl sulfate (further details on this preparation method are disclosed in U.S. Pat. No. 3,915,867). Using this ratio controls the amount of each of monoesterquat, diesterquat, and triesterquat in the composition. In certain embodiments, the alkanol amine comprises triethanolamine. In certain embodiments, it is desirable to increase the amount of diesterquat and minimize the amount of triesterquat to increase the softening capabilities of the composition. By selecting a ratio of about 1.65, the triesterquat can be minimized while increasing the monoesterquat.

Monoesterquat is more soluble in water than triesterquat. Depending on the AI, more or less monoesterquat is desired. At higher AI levels (usually at least 7%), more monoesterquat as compared to triesterquat is desired so that the esterquat is more soluble in the water so that the esterquat can be delivered to fabric during use. At lower AI levels (usually up to 3%), less monoesterquat is desired because during use, it is desired for the esterquat to leave solution and deposit on fabric to effect fabric softening. Depending on the AI, the amount of monoesterquat and triesterquat are adjusted to balance solubility and delivery of the esterquat.

In certain embodiments, the reaction products are 50-65 weight % diesterquat, 20-40 weight % monoester, and 25 weight % or less trimester. In other embodiments, the amount of diesterquat is 52-60, 53-58, or 53-55 weight %. In other embodiments, the amount of monoesterquat is 30-40 or 35-40 weight %. In other embodiments, the amount of triesterquat is 1-12 or 8-11 weight %.

The percentages, by weight, of mono, di, and tri esterquats, as described above are determined by the quantitative analytical method described in the publication “Characterisation of quaternized triethanolamine esters (esterquats) by HPLC, HRCGC and NMR” A. J. Wilkes, C. Jacobs, G. Walraven and J. M. Talbot—Colgate Palmolive R&D Inc. - 4th world Surfactants Congress, Barcelone, 3-7 VI 1996, page 382. The percentages, by weight, of the mono, di and tri esterquats measured on dried samples are normalized on the basis of 100%. The normalization is required due to the presence of 10% to 15%, by weight, of non-quaternized species, such as ester amines and free fatty acids. Accordingly, the normalized weight percentages refer to the pure esterquat component of the raw material. In other words, for the weight % of each of monoesterquat, diesterquat, and triesterquat, the weight % is based on the total amount of monoesterquat, diesterquat, and triesterquat in the composition.

In certain embodiments, the percentage of saturated fatty acids based on the total weight of fatty acids is 45 to 75%. Esterquat compositions using this percentage of saturated fatty acids do not suffer from the processing drawbacks of 100% saturated materials. When used in fabric softening, these compositions provide good consumer perceived fabric softness while retaining good fragrance delivery. In other embodiments, the amount is at least 50, 55, 60, 65 or 70 up to 75%. In other embodiments, the amount is no more than 70, 65, 60, 55, or 50 down to 45%. In other embodiments, the amount is 50 to 70%, 55 to 65%, or 57.5 to 67.5%. In one embodiment, the percentage of the fatty acid chains that are saturated is about 62.5% by weight of the fatty acid. In this embodiment, this can be obtained from a 50:50 ratio of hard:soft fatty acid.

By hard, it is meant that the fatty acid is close to full hydrogenation. In certain embodiments, a fully hydrogenated fatty acid has an iodine value of 10 or less. By soft, it is meant that the fatty acid is no more than partially hydrogenated. In certain embodiments, a no more than partially hydrogenated fatty acid has an iodine value of at least 40. In certain embodiments, a partially hydrogenated fatty acid has an iodine value of 40 to 55. The iodine value can be measured by ASTM D5554-95 (2006). In certain embodiments, a ratio of hard fatty acid to soft fatty acid is 70:30 to 40:60. In other embodiments, the ratio is 60:40 to 40:60 or 55:45 to 45:55. In one embodiment, the ratio is about 50:50. Because in these specific embodiments, each of the hard fatty acid and soft fatty acid cover ranges for different levels of saturation (hydrogenation), the actual percentage of fatty acids that are fully saturated can vary. In certain embodiments, soft tallow contains approximately 47% saturated chains by weight.

The percentage of saturated fatty acids can be achieved by using a mixture of fatty acids to make the esterquat, or the percentage can be achieved by blending esterquats with different amounts of saturated fatty acids.

The fatty acids can be any fatty acid that is used for manufacturing esterquats for fabric softening. Examples of fatty acids include, but are not limited to, coconut oil, palm oil, tallow, rape oil, fish oil, or chemically synthesized fatty acids. In certain embodiments, the fatty acid is tallow. For example, the esterquat may be a hydrogenated tallow esterquat, such as TETRANYL L1/90, available commercially from Kao chemicals, Tokyo, Japan.

While the esterquat can be provided in solid form, it is usually present in a solvent in liquid form. In solid form, the esterquat can be delivered from a dryer sheet in the laundry. In certain embodiments, the solvent comprises water.

AI refers to the active weight of the combined amounts for monoesterquat, diesterquat, and triesterquat. Delivered AI refers to the mass (in grams) of esterquat used in a laundry load. A load is 3.5 kilograms of fabric in weight. As the size of a load changes, for example using a smaller or larger size load in a washing machine, the delivered AI adjusts proportionally. In certain embodiments, the delivered AI is 2.8 to 8 grams per load. In other embodiments, the delivered AI is 2.8 to 7, 2.8 to 6, 2.8 to 5,3 to 8, 3 to 7,3 to 6,3 to 5,4 to 8,4 to 7,4 to 6, or 4 to 5 grams per load.

In one embodiment, the fabric care composition includes 20 weight % or less fabric softening agent, based on a total weight of the fabric care composition. In certain embodiments, the fabric care composition includes 15 weight % or less, 10 weight % or less, or 5 weight % or less fabric softening agent. In other embodiments, the fabric care composition includes 3 weight or less, 2 weight % or less, or 1 weight % or less fabric softening agent. For example, the fabric care composition may include 4 weight % or less quaternized triethanolamine diester. Typically, when included, the fabric care compositions include at least 0.5 weight % fabric softening agent.

The fabric care composition also includes a co-softening agent. The co-softening agent may be a polyquaternium polymer. According to one embodiment, the co-softening agent is a stable, water-soluble, and liquid polyquaternium polymer. For example, the co-softening agent may be polyquaternium-7. Polyquaternium-7 (PQ7) is the copolymer of acrylamide and diallyldimethylammonium chloride, and is usually represented with the following chemical formula: (C₈H₁₆CIN)ₙ(C₃H₅NO)ₘ. Polyquaternium-7 is available commercially as NOVERITE 300 from Lubrizol Corporation, Wickliffe, Ohio, and as FLOCARE LS737, from SNF Floerger, Andrézieux, France.

As described herein, the inventors have surprisingly discovered that, compared to other polyquaternium polymers, PQ7 provides considerable advantages. For example, PQ7 is typically provided in a liquid dispersion. This facilitates its use in continuous manufacturing systems. PQ7 also form stable mixtures compared with mixtures using powder or solid polyquaternium polymers. The fabric conditioning performance of PQ7 was also unexpected in view of the low amounts of this material used, and such performance cannot be realized by other polyquaternium polymers (e.g. Polyquaternium 67, Polyquaternium 5, etc.). The use of PQ7 also displayed improved fragrance delivery in some important key touch points for consumers.

In one embodiment, the fabric care composition includes up to 0.30 weight % co-softening agent (e.g., polyquaternium-7), based on the total weight of the fabric care composition. In other embodiments, the fabric care composition includes from 0.05 weight % to 0.25 weight % co-softening agent or from 0.05 weight % to 0.20 weight % co-softening agent. For example, the fabric care composition may include from 0.5 weight % to 0.25 weight % polyquaternium-7.

In another embodiment, the amount of co-softening agent in the fabric care composition may be determined by the amount of fabric softening agent to be replaced. That is, the inventors have surprisingly discovered a method of reducing the fabric softening agent (e.g., esterquat) content of a known fabric care composition with established performance characteristics (e.g., softness, fragrance delivery, ease of ironing, wrinkly reducing, dispersion, etc.) by substitution with a co-softening agent (e.g., PQ7) while maintaining similar or superior performance characteristics. For example, the amount of co-softening agent in the fabric care composition may be determined by the following formula.

Y=−0.0043X²+0.0649X−0.0037 Formula 2:
wherein X is the amount of fabric softening agent (e.g., esterquat) to be replaced, and Y is the amount of co-softening agent (e.g., PQ7) needed to provide a similar performance to the X amount of fabric softening agent.

Formula 2 can be used to reduce the amount of fabric softening agent of a known fabric softening agent-containing fabric care composition while maintaining a comparable performance. For example, under Formula 2, 1 weight % of fabric softening agent (e.g., esterquat) may be replaced with about 0.06% of co-softening agent (e.g., polyquaternium-7). That is, a known esterquat-containing fabric care composition may be modified to include 1 weight % less esterquat for each 0.06 weight % polyquaternium-7 added. In another embodiment, 2 weight % of esterquat may be replaced with about 0.11% weight % polyquaternium-7, or 3 weight % of esterquat may be replaced with about 0.15% weight % polyquaternium-7.

In some embodiments, the combination of the fabric softening agent (e.g., esterquat) and co-softening agent (e.g., polyquaternium-7) form a fabric softening agent mix. The fabric softening agent mix may form a stable liquid mixture that does not separate when stored at room temperature. The fabric softening agent mix may form a water-soluble mixture.

The fabric care composition may be substantially free of fabric softeners other than the fabric softening agent and the co-softening agent. For example, in some embodiments, other than esterquat, the fabric care composition is substantially free of any other fabric softening agents. In some embodiments, other than polyquaternium-7, the fabric care composition is substantially free of any other co-softening agents. In some embodiments, other than esterquat and polyquaternium-7, the fabric care composition is substantially free of any other fabric softening agents and co-softening agents, respectively.

Esterquats may be considered a cationic surfactant. In some embodiments, the fabric care composition is substantially free of surfactants other than the fabric softening agent. For example, the fabric care composition is substantially free of surfactants other than esterquat. In some embodiments, the fabric care composition is substantially free of detersive surfactants. In another embodiment, the fabric care composition is substantially free of anionic surfactants.

The fabric care composition may include an aqueous carrier. For example, the fabric care composition may include water as the carrier. In certain embodiments, the amount of water is at least 30%, 40%, 50%, 60%, 70%, 80%, or 85% by weight of the composition. In one embodiment, the fabric care composition includes 25 weight % or more water, based on the total weight of the fabric care composition. In other embodiments, the fabric care composition includes 50 weight % or more water or 75 weight % or more water, based on the total weight of the fabric care composition.

In some embodiments, the fabric care composition may be a low-water or “concentrated” formulation intended to be diluted before use. In such embodiments, the fabric care composition includes lower amounts of the aqueous carrier. In certain embodiments, the amount of water is no more than 50%, 40%, 30%, 20%, 15%, or 10% by weight of the composition. For example, the fabric care composition may include 50 weight % or less water or 30 weight % or less water, based on the total weight of the fabric care composition.

The fabric care composition may also include other components commonly used in fabric care compositions in minor amounts to enhance either the appearance or performance of the fabric care compositions. For example, the fabric care composition may include thickeners, fragrances, preservatives, colorants such as dyes or pigments, bluing agents, germicides, and opacifying agents.

In some embodiments, the fabric care composition must be easily pourable by an end user. Accordingly, the viscosity of the fabric care composition should not exceed 500 centipois (cP) for ready-to-use fabric care compositions, preferably not more than 250 cP, and 10,000 cP for fabric care composition intended for dilution before use. In one embodiment, the fabric care composition has a pour viscosity from 30 to 500 cP, or from 50 to 200 cP. Unless otherwise specified, viscosity is measured at 25° C. using a Brookfield RVTD Digital Viscometer with Spindle #2 at 50 rpm.

In order to adjust the viscosity, the fabric care composition may include one or more thickeners. The one or more thickeners may include cationic polymeric thickeners that are water soluble and with a high molecular weight. For example, the thickener can be a cross-linked cationic polymer such as FLOSOFT DP200. FLOSOFT DP200 is commercially available from SNF Floerger, and is described in U.S. Pat. No. 6,864,223 to Smith et al. FLOSOFT DP200 is a water soluble cross-linked cationic polymer derived from the polymerization of from 5 to 100 mole percent of cationic vinyl addition monomer, from 0 to 95 mole percent of acrylamide, and from 70 to 300 ppm of a difunctional vinyl addition monomer cross-linking agent.

Other suitable thickener are water-soluble cross-linked cationic vinyl polymers which are cross-linked using a cross-linking agent of a difunctional vinyl addition monomer at a level of from 70 to 300 ppm, preferably from 75 to 200 ppm, and most preferably of from 80 to 150 ppm. These polymers are further described in U.S. Pat. No. 4,806,345, and other polymers that may be utilized are disclosed in WO 90/12862. Generally, such polymers are prepared as water-in-oil emulsions, wherein the cross-linked polymers are dispersed in mineral oil, which may contain surfactants. During finished product making, in contact with the water phase, the emulsion inverts, allowing the water soluble polymer to swell. The most preferred thickener may be a cross-linked copolymer of a quaternary ammonium acrylate or methacrylate in combination with an acrylamide comonomer. The thickener may provide the fabric care composition long term stability upon storage and allows the presence of relatively high levels of electrolytes without affecting the composition stability. Additionally, the fabric care compositions remain stable when shear is applied thereto. In certain embodiments, the amount of this thickening polymer is at least 0.001 weight %. In other embodiments, the amount is 0.001 to 0.35 weight %.

In one embodiment, the fabric care composition includes 0.5 weight % or less thickener, based on the total weight of the fabric care composition. In other embodiments, the fabric care composition includes 0.1 weight % or less thickener or 0.05 weight % or less thickener, based on the total weight of the fabric care composition

The fabric care composition may include one or more fragrances, fragrance oils, or perfumes. As used herein, the term “fragrance” is used in its ordinary sense to refer to and include any non-water soluble fragrant substance or mixture of substances including natural (i.e., obtained by extraction of flower, herb, blossom or plant), artificial (i.e., mixture of natural oils or oil constituents) and synthetically produced odoriferous substances. As used herein, fragrance, or perfume, refers to odoriferous materials that are able to provide a desirable fragrance to fabrics, and encompasses conventional materials commonly used in detergent compositions to provide a pleasing fragrance and/or to counteract a malodor. The fragrances are generally in the liquid state at ambient temperature, although solid fragrances can also be used. Fragrance materials include, but are not limited to, such materials as aldehydes, ketones, esters and the like that are conventionally employed to impart a pleasing fragrance to laundry compositions. Naturally occurring plant and animal oils are also commonly used as components of fragrances.

The fabric care composition may include free fragrances, encapsulated fragrances, or a mixture of both.

In other embodiments, the fabric care composition may be provided as a fragrance-free composition. The amount of fragrance can be any desired amount depending on the preference of the user. In certain embodiments, the total amount of fragrance is from 0.3 weight % to 3 weight % based on the total weight of the fabric care composition. The fragrance can be in free form, encapsulated, or both.

The fabric care composition may include one or more preservatives. The one or more preservatives may include one or more organic acids, such as lactic acid and/or phosphonic acid. For example, the fabric care composition may include combinations of food grade lactic acid and amino trimethyl phosphonic acid. In certain embodiments, the fabric care composition may also include isothiazolinones as preservatives. For example, the one or more preservatives may include a (OIT/MIT/CIT) isothiazolinone mixture. Suitable isothiazolinone preservatives include the isothiazolinones sold under the trademark KATHON DP3 and available from Rohm & Haas.

In one embodiment, the fabric care composition includes 0.2 weight % or less preservative, based on the total weight of the fabric care composition. In other embodiments, the fabric care composition includes 0.15 weight % or less preservative or 0.10 weight % or less preservative, based on the total weight of the fabric care composition.

### EXAMPLES

Table 1 illustrates a performance comparison of an esterquat-containing fabric softening composition (4.5% esterquat—Comparative Composition 1) against fabric care compositions according to the present disclosure replacing certain amounts of esterquat with PQ7.

The compositions of Table 1 were prepared as follows: water was heated to 50° C. A pre-heated amount of esterquat (55° C.) was then added to the water and mixed at 150-200 rpm for 10-15 minutes using a double paddle agitator. The fragrance was then added while continuing to mix at 150-200 rpm for 15 minutes. The rest of the components were then added while continuing to mix at 2000 rpm for 10 minutes.

The compositions of Table 1 were used in the fabric softener cycle of a load of cotton swatches laundered as follows: approximately 2.5 kg of cotton swatches (100% white cotton towel, 30 cm×30 cm) were loaded into a top loading washing machine. The wash cycle was set to “Normal,” the wash time was set to 12 minutes, and the wash level was set to 60 liters for all wash and rinse cycles. The wash and rinse temperatures were sent to room temperature. 27 gr of detergent (TIDE liquid, P&G) for use in the wash cycle and 55 gr (1 cap) of the compositions of Table 1 to be used in the rinse cycle were added to the respective compartments in the washing machine.

The laundered cotton swatches were then dried in a tumble dryer at a high temperature setting (92±3° C.) for at least 1 hour. Before testing for softness, the cotton swatches were pre-conditioned by placing them in a room at 25±2° C. and 50±5% relative humidity for at least 12 hours prior to conducting softness evaluation.

The softness of the laundered and dried cotton swatches was then evaluated using a panel. The panel performed individual softness assessments on randomized pairs of cotton swatches, and each panelist assigned the softer swatch a grade of 1 while the swatch that is perceived as being less soft was assigned a grade of 2. Statistical analysis was then performed on the total panel results to establish a comparative softness range establishing parity, requirements for the comparative composition.

TABLE 1

| | Compar- | Exam- | Exam- | Exam- | Exam- | Exam- |
|---|---|---|---|---|---|---|
| | ative | ple | ple | ple | ple | ple |
| Component | Comp. 1 | A1 | A2 | A3 | A4 | A5 |
| Water | q.s. | q.s. | q.s. | q.s. | q.s. | q.s. |
| Esterquat | 4.5% | 4.05% | 3.60% | 3.15% | 2.70% | 2.25% |
| PQ7 | — | 0.02% | 0.05% | 0.08% | 0.10% | 0.12% |
| Thickener | 0.25% | 0.25% | 0.25% | 0.25% | 0.25% | 0.25% |
| Colorants | 0.003% | 0.003% | 0.003% | 0.003% | 0.003% | 0.003% |
| Preservatives | 0.06% | 0.06% | 0.06% | 0.06% | 0.06% | 0.06% |
| Fragrance | 0.27% | 0.27% | 0.27% | 0.27% | 0.27% | 0.27% |
| Average | 64 | 73 | 67 | 55 | 71 | 67 |
| Softness | | | | | | |

Parity in softness performance can be determined by a softness score between 51 and 77. As illustrated in Table 1, Example compositions A1-A5 replacing between 10-50 weight % of the esterquat with PQ7 had an equivalent softness performance.

Table 2 illustrates a performance comparison of another esterquat-containing fabric softening composition (10.2% esterquat—Comparative Composition 2) against fabric care compositions according to the present disclosure replacing certain amounts of esterquat with PQ7.

The compositions of Table 2 were prepared and tested under the same conditions as those of Table 1.

TABLE 2

| | Comparative | Example | Example | Example | Example | Example |
|---|---|---|---|---|---|---|
| Component | Comp 2. | B1 | B2 | B3 | B4 | B5 |
| Water | 85.43 | 85.99 | 86.64 | 87.40 | 88.27 | 89.26 |
| Colorant | 0.0067 | 0.0067 | 0.0067 | 0.0067 | 0.0067 | 0.0067 |
| Preservative (DP3) | 0.02 | 0.02 | 0.02 | 0.02 | 0.02 | 0.02 |
| PQ7 | 0.0000 | 0.069 | 0.130 | 0.179 | 0.216 | 0.242 |
| Esterquat | 12.5 | 11.25 | 10.00 | 8.75 | 7.50 | 6.25 |
| (Tetranyl L2-90) | | | | | | |
| Thickener | 1.0 | 1.0 | 1.0 | 1.0 | 1.0 | 1.0 |
| Fragrance Oil | 0.87 | 0.87 | 0.87 | 0.87 | 0.87 | 0.87 |
| Fragrance Capsules | 0.15 | 0.15 | 0.15 | 0.15 | 0.15 | 0.15 |
| Average softness | 64 | 74 | 65 | 65 | 70 | 68 |

Parity in softness performance can be determined by a softness score between 51 and 77. As illustrated in Table 2, the Example compositions B1-B5 replacing between 10-50 weight % of a high-esterquat composition with PQ7 had an equivalent softness performance.

Tables 3-5 illustrates a performance comparison of a commercially available esterquat-containing fabric softening composition (3.06% esterquat—SOUPLINE GRAND AIR) against the fabric care compositions of Table 3 replacing certain amounts of esterquat with PQ7.

TABLE 3

| | Comparative | | |
|---|---|---|---|
| Component | Comp. 3 | Example C1 | Example C2 |
| Water | q.s. | q.s. | q.s. |
| Esterquat (90% A.I.) | 3.06% | 2.7% | 2.4% |
| PQ7 | — | 0.37% | 0.47% |
| (10% A.I) | | | |
| Thickener | 0.28% | 0.31% | 0.05% |
| Colorants | 0.0015% | 0.0015% | 0.0015% |
| Lactic Acid | 0.1% | 0.1% | 0.1 |
| (88% solids) | | | |
| Amino Trimethyl | 0.1% | 0.1% | 0.1% |
| Phosphonic Acid | | | |
| (88% solids) | | | |
| Fragrance | 0.26% | 0.26% | 0.26% |

The fabric care compositions of Table 3 were prepared similarly as the fabric care compositions of Tables 1-2. The performance of the fabric care compositions of Table 3 was compared to a commercially available esterquat-containing fabric softening composition diluted to a 3.06% esterquat content with respect to ease of ironing, wrinkle reduction, and softness.

The ease of ironing was tested as follows: 2.5 Kg of denim swatches were laundered and dried as described above with respect to Tables 1-2. 74 mL of the fabric care compositions of Table 3 were added during the rising step. Each denim swatch was extended over an ironing board and ironed using a commercial iron set to a “cotton” temperature. The iron had a digital dynamometer attached to its top and a pulling cable attached to its front end connected to an electric motor. The iron was placed on one end of the denim swatch and pulled along its surface. Dynamometer readings (in grams-force) were made every 20 cm for 100 cm and duplicated on other sections of the denim swatch. The average of readings obtained were subject to statistical analysis using a Paired t-test model at 95% C.I. Lower force readings (in grams-force) would indicate an easier ironing performance achieved by the treatment given to the denim swatches.

The wrinkle reduction was tested as follows 20 cm×20 cm denim swatches were laundered and dried as described above with respect to Tables 1-2 a total of 5 times. 74 mL of the fabric care compositions of Table 3 were added during the rising step. 100% cotton 120 cm×50 cm swatches were added to complete the wash load size. After the fifth wash, the denim swatches were taken out of the rinse step and twisted with a 90 degree movement of the hands to promote wrinkle formation. The denim swatches were then line dried for 36 hours at 22-25° C. and 45 to 55% relative humidity. The dry denim swatches were then placed in a well illuminated area to identify and count the number of wrinkles formed. Data from 10 swatches for each fabric care composition were then averaged and then subject to statistical analysis using a Paired t-test model at 95% C.I.

The softness was tested using a Phabrometer instrument (Australian Wool testing Authority Ltd., Sydney, Australia) and an average softness was calculated. This instrument determines friction force created by circular swatches when they go through a calibrated orifice. Readings of the friction force are related to the softness of the fabrics (less friction force means more softness).

TABLE 4

| | | Soupline Grand Air diluted |
|---|---|---|
| Test | Example C1 | variant at 3.06% A.I. |
| Ease of Ironing | 122.3 | 128.8 |
| (grams-force) | | |
| Wrinkle Reduction | 8.8 | 15.2 |
| (average number of wrinkles) | | |
| Average Softness (dynes) | 3.4 | 5.4 |

As illustrated in Table 4, the fabric care composition of Example C₁ with 2.43% A.I. esterquat had equivalent or superior results to the 3.06% A.I. esterquat of the comparative composition with respect to ease of ironing, wrinkle reduction, and softness.

TABLE 5

| | Example | Soupline Grand Air diluted |
|---|---|---|
| Test | C2 | variant at 3.06% A.I. |
| Ease of Ironing | 121.3 | 128.8 |
| (grams-force) | | |
| Wrinkle Reduction | 10.0 | 14.5 |
| (average number of wrinkles) | | |
| Average Softness (dynes) | 3.2 | 5.3 |

As illustrated in Table 5, the fabric care composition of Example C₂ with 2.34% A.I. esterquat had equivalent or superior results to the 3.06% A.I. esterquat of the comparative composition with respect to ease of ironing, wrinkle reduction, and softness.

In addition, fragrance, dispersion, and residue tests confirm that the fabric care compositions of the present disclosure have equivalent or superior performance to that of esterquat-containing compositions when replacing a portion of the esterquat content with PQ7.

As can be seen from the data above, the esterquat content of a fabric care composition can be reduced by substitution with a much lesser amount of PQ7 while maintaining equivalent or superior performance characteristics.

The present disclosure has been described with reference to exemplary embodiments. Although a few embodiments have been shown and described, it will be appreciated by those skilled in the art that changes may be made in these embodiments without departing from the principles and spirit of preceding detailed description. It is intended that the present disclosure be construed as including all such modifications and alterations insofar as they come within the scope of the appended claims or the equivalents thereof.

1-12. (canceled)

13. A method of creating a reduced-esterquat fabric care composition, comprising:
determining the amount of esterquat in a known fabric care composition;
modifying the known fabric care composition by substituting X weight % esterquat with Y weight % polyquaternium-7; and
creating a reduced-esterquat fabric care composition based on the modified fabric care composition,
wherein the reduced-esterquat fabric care composition has at least an equivalent performance to the known fabric care composition with respect to at least one of softness, ease of ironing, and wrinkle reduction, and
wherein X is greater than Y.

14. The method of claim 13, wherein the reduced-esterquat fabric care composition comprises no surfactants other that the esterquat.

15. The method of claim 13, wherein the reduced-esterquat fabric care composition comprises no other fabric softening agents other that the esterquat and the polyquaternium-7.

16. The method of claim 13, wherein the reduced-esterquat fabric care composition has a viscosity from 50 to 300 cP.

17. The method of claim 13, wherein the reduced-esterquat fabric care composition further comprises:
an aqueous carrier;
from 0.3 weight % to 3 weight % fragrance;
0.001 weight % or more thickener; and
0.2 weight % or less preservative.

18. The method of claim 13, which produces a fabric care composition comprising:
a fabric softening agent in an amount of 20 weight % or less, based on a total weight of the fabric care composition, wherein the fabric softening agent comprises esterquat; and
a co-softening agent in an amount of 0.30 weight % or less, based on the total weight of the fabric care composition, wherein the co-softening agent comprises polyquaternium-7.

19. The method of claim 18, wherein the fabric care composition as produced further comprises:
an aqueous carrier;
a fragrance;
a thickener;
a preservative; and
a colorant.

20. The method of claim 18, wherein the fabric care composition as produced comprises:
15 weight % or less esterquat;
from 0.05 weight % to 0.25 weight % polyquaternium-7;
from 0.3 weight % to 3 weight % fragrance;
0.001 weight % or more thickener; and
0.2 weight % or less preservative.

21. The method of claim 18, wherein the fabric care composition as produced comprises a fabric softening agent mixture consisting essentially of 5 weight % or less esterquat and from 0.05 weight % to 0.20 weight % polyquaternium-7, based on a total weight of the fabric care composition, wherein the fabric care composition comprises no other fabric softening agents.

22. The method of claim 21, wherein the fabric softening agent mixture is a stable and water soluble liquid mixture.

23. The method of claim 13, wherein Y=−0.0043X²+0.0649X−0.0037, X is the amount of esterquat to be replaced with polyquaternium-7, and Y is the amount of polyquaternium-7 used to replace esterquat.
